(19) United States
(12) Patent Application Publication
(10) Pub. No.: US 2014/0286778 A1
(43) Pub. Date: Sep. 25, 2014

(54) UNIT FOR ROTATING CABLE SPACING PLATES IN A WIND TURBINE TOWER

(71) Applicant: Envision Energy (Denmark) ApS, Silkeborg (DK)

(72) Inventor: Henning Moestrup, Viborg (DK)

(73) Assignee: Envision Energy (Denmark) ApS, Silkeborg (DK)

(21) Appl. No.: 14/217,756

(22) Filed: Mar. 18, 2014

(30) Foreign Application Priority Data
Mar. 25, 2013 (DK) PA 2013 70176

(51) Int. Cl. F03D 1/06

(52) U.S. Cl. CPC F03D 1/06
USPC 416/205

(57) ABSTRACT

A wind turbine having a wind turbine tower with a nacelle provided on the top to which a rotor hub with one or more wind turbine blades is rotatable mounted. A cable twisting system is arranged inside the wind turbine tower and suspended from the bottom of the nacelle. The cable twisting system comprises a number of cable spacing plates having a number of guiding means for guiding the electrical cables from the nacelle to the bottom of the wind turbine tower. A first and second element having engaging fingers configured to be brought into contact with each other are coupled to two adjacent cable spacing plates. The first element rotates relative to the second element when the nacelle is yawing, bringing the fingers into contact with each other. The two elements then rotate together as the nacelle continues to yaw in the same direction.

### BACKGROUND OF THE INVENTION

1. Field of the Invention

The present invention relates to a wind turbine comprising:

a wind turbine tower having an inner side, a bottom, and a top;

a nacelle arranged at the top of the wind turbine tower, wherein the nacelle is coupled to at least one yawing unit configured to rotate the nacelle relative to the wind turbine tower;

a rotor hub rotatably mounted to the nacelle, where at least one wind turbine blade is mounted to the rotor hub;

a cable twisting system configured to be arranged inside the wind turbine tower, where the cable twisting system comprises a number of cable spacing plates coupled to at least one suspension element, wherein the cable spacing plates are distributed along a length of the cable twisting system and comprise a number of guiding means configured to guide a number of electrical cables extending out from the bottom of the nacelle and into the inside of the wind turbine tower in a direction towards the bottom of the wind turbine tower.

2. Description of Related Art

It is well known to transmit the power generated in a nacelle, which is located at the top of a wind turbine tower, to electrical cables located at the bottom of the wind turbine using another set of electrical cables extending along the inside of the tower. The cables located inside the tower are typically connected to a generator, a converter, or other electrical equipment in the nacelle, and the cables at the bottom of the tower are typically connected to cables extending underground or along the seabed to e.g.,a substation or another station.

In order to allow the nacelle to make yaw movements relative to the tower of the wind turbine, these cables are arranged in the centre of the tower, so that pulling in the cable is minimized and twisting becomes the most important issue. The cables typically hang free from the tower and are often guided downwards along a number of rings/frames and/or a so-called cable stocking so that the cables are only guided into a forced rotation. Such a cable stocking is typically located near the top of the wind turbine tower and/or mounted to the bottom of the nacelle. The cable stocking is often a fixture installed on or around the cable and is fitted with a recess or hole through which the cable may extend. As the nacelle is yawing, the free-hanging cables will twist over a certain length causing the lower part of the cables to be lifted as the cables tend to take a helical shape during the twist. In order to compensate for this, it is common to form a so-called cable loop at the bottom of the free-hanging cables.

When the cables are being twisted, they will tend to hold the lowest level of potential energy which means that the heaviest part (the upper part) of the cables will twist less than the lightest part (the lower part) of the cables. This means that the cable spacing plates in the bottom of the tower will have a tendency to be the only ones that turn when the nacelle is yawing because of the gravity acting on the cables and the spacing plates. A high rate or portion of twist over a short length may lead to rubbing between the cables and the guided structure which increases the wear on the cables and decreases the lifetime of cables extensively. This may also lead to clogging the cables resulting in a change of the thermal cooling conditions, thereby increasing the cable temperature to an unacceptable level which also decreases the lifetime of cables.

Wind turbines today typically comprise a module or function which senses the yaw of the nacelle or the cable twist. When the module or function senses that the cable or nacelle has reached its maximum twist threshold, then the wind turbine stops and rotates the cable or nacelle back into its initial position, e.g., zero degrees, thereby untwisting the cables. The guiding structures are typically designed to operate with a maximum twist of ±720-1080 degrees; some may even have a maximum of ±1800 degrees.

From U.S. Patent Application Publication 2010/0247326 A1, a solution as described above is known. A number of cables are hanging from the main structure at the nacelle, where the cables are situated in the centre of the tower. The cables are guided through a plurality of holes in a number of circular shaped plates in which the cables are arranged in bundles along the outer periphery of the plates. The plates are held in their respective positions on a suspension wire or rod using clamping fasteners where the suspension wire/rod is attached to the nacelle. The lowermost plate is attached to the inner sidewall of the wind turbine tower using fixtures so that the plate does not rotate relative to the tower when the cables are twisted. As the cables are held in place by the holes in the plates, there will be a bend in the cables below and above the plate when the cables are twisted which over time will destroy the cable and the cable has to be replaced, with down time and high costs as a consequence.

Since the lowermost plate is prevented from rotating, the cables will be sliding in and out of the holes in that plate which quickly will wear out the insulation around the conducting material on the cables. This problem is to some extend addressed by preparing the plates with holes having edges which are rounded off, but as the individual cables are twisted they will be forced towards these edges and they will wear and fail such that a short circuit might appear. A further disadvantage is that the cables have to be installed from the bottom up or from the top down by guiding each and every cable through a number of holes in the plates. This is a troublesome and time-consuming process and thus also expensive.

Another problem with the solution disclosed in U.S. Patent Application Publication 2010/0247326 A1 is to get rid of heat emitted from the cables because they are arranged in small bundles relatively close to each other on a relative small plate. The reason for having a small diameter of the plates is believed to be an attempt to minimize the distance between the cables having to travel up and down during twisting. A small diameter demands less travel of the cables and vice versa, but it will increase the deformation of the cables and also stresses the cables. Furthermore, since the bundles of cables will be more compact using a small plate, less heat will be moved away by natural convection.

Chinese Utility Model CN 202004388 U discloses a circular cable spacer for a wind turbine having a number of fingers extending in a radial direction outwards from a centre part of the spacer. The fingers form a number of gaps configured for receiving the cables. The length of the fingers is less than the diameter of the cables so a clamping band is used to press and hold the cables in position in the gaps. When the cables are twisted, they will take a shape similar to that of an hour glass, thus bringing the cables into contact with the edges of contacting surfaces. This configuration has the drawback that the contacting surfaces form a number of sharp edges which will damage the insulation of the cables and eventually causing the cables to fail. Furthermore, since the cables are held in place by the clamping band, there will be a bending of the cables at both sides of the cables spacer. This will also damage the cable over time.

Chinese Utility Model CN 201568227 U discloses a similar cable spacer comprising fingers for holding the cables in position. This solution also suffers from the drawbacks of wear and bending as discussed above. This solution has to be installed piece by piece in order to arrange the cables between the fingers. Furthermore, the fingers on the outermost periphery have a depth which is less than the diameter of the cables and the cables are not held in place. Thus, there is a high risk that one of the cables will glide out of its position between the fingers.

### SUMMARY OF THE INVENTION

An object of the invention is to provide a cable twisting system which rotates the individual plates in a uniform manner.

An object of the invention is to provide a unit for rotating cable spacing plates which may be mounted to a cable twisting system.

An object of the invention is achieved by a wind turbine, characterised in that

a first element is configured to be firmly coupled to a first cable spacing plate, wherein the first element extends out from the first cable spacing plate towards a second cable spacing plate when mounted;

a second element is configured to be firmly coupled to the second cable spacing plate, wherein the second element extends out from the second cable spacing plate towards the first cable spacing plate when mounted; and

wherein the first element is configured to rotate relative to the second element when the nacelle is yawing until a first contact surface on the first element is brought into contact with a second contact surface on the second element, after which the first and second elements are rotated together.

This allows the individual cable spacing plates to be rotated in a uniform manner when the nacelle is yawing. The use of two engaging elements allows the twisting of the cables extending downwards from the nacelle to be distributed in a uniform manner along the length of the cable twisting system. This further reduces the bending forces acting on the cables and the wearing of the insulation on the electrical cables. The two engaging elements may be positioned in all or a number of the sections formed by the individual cable spacing plates. The two elements may be positioned relative to each other so that the two contact surfaces are offset relative to the each other when the nacelle is positioned in its neutral position, i.e., has a yawing angle of zero. This allows the two elements to be brought into contact or engagement by rotating the upper cable spacing plate relative to the lower cable spacing plate, or vice versa. The two cable spacing plates is then rotated together or simultaneously due to the engagement between the two elements. The lower or upper cable spacing plate may then rotate relative to a third adjacent cable spacing plate until another set of engaging elements coupled to these two cable spacing plates are brought into contact with each other, and so on. This allows rotation of each cable spacing plate relative an adjacent cable spacing plate to be limited to a maximum rotational angle defined by the two engaging elements. The first and second elements form a unit for rotating the cable spacing plates which may be mounted to the cable twisting system after it has been mounted inside the wind turbine tower.

The cable spacing plates may be made of metal (e.g.,iron or steel), plastics (e.g.,polycarbonate, polyester or polymer), glass/organic fibre reinforced plastics/composite or another suitable material. If the cable spacing plates are made of metal, they may be at least partly covered with a protective and/or friction reducing plastic, coating or skin. The cable spacing plates may be coupled to each other by means of one or more suspension elements in the form of a torsion rod or spring or two or more suspension wires or ropes. The suspension wire may be formed by a single wire extending through all the cable spacing plates where the individual cable spacing plates may be coupled to the wire by means of clamps or bushings. Instead a number of suspension wires may be coupled to two adjacent cable spacing plates.

According to one embodiment, a third element is configured to be coupled to at least one of the first and second elements, wherein the third element is configured to guide the movement of the second element in an axial direction relative to the first element when the nacelle is yawing.

This allows the first and second elements to be guided into a correct position relative to each other so that an optimal engagement is achieved, i.e., the two contact surfaces are aligned over each other. The third element is used to keep the first and second elements aligned relative to each other when the upper cable spacing plate is rotated relative to the lower cable spacing plate. The third element may be configured to guide the movement of the second element relative to the first element in an axial and/or radial direction, or vice versa. The third element further allows the cable spacing plates to be aligned in an axial direction relative to each other so that any lateral movement of the cable spacing plates are eliminated or at least reduced to a minimum.

The third element may be formed as a part of the first or second element in order to ensure a strong load transferring coupling between the two pieces. The third element may instead be firmly coupled to the first or second element by means of welding, gluing, bonding or another suitable fastening technique or by use of fastening means in the form of bolts, nuts, screws, rivets or another suitable fastening means. The third element may alternatively be coupled directly to the first or second cable spacing plate, e.g.,a part thereof, by means of the above-mentioned fastening techniques or fastening means. The first or second element may then be arranged on the third element and coupled to the third element, e.g.,using above-mentioned fastening techniques or fastening means or a bushing or sleeve.

The first, second and/or third element may be made of metal, e.g.,iron or steel, or plastics, e.g.,polycarbonate, polyester or polymer, glass/organic fibre reinforced plastics/composite or another suitable material.

According to a particular embodiment, the third element comprises at least one free end and the first or second element comprises a recess configured to at least partly receive the free end when mounted, wherein the free end is configured to be moved along the recess when the nacelle is yawing.

The yawing of the nacelle causes the upper cable spacing plate to rotate relative to the lower cable spacing plate as the cables are twisted which causes the lower cable spacing plate to be moved towards the upper cable spacing plate in a substantially axial direction, or vice versa. This allows the third element to guide the second element into the correct position relative to the first element by moving the third element further into the recess or along the length of the recess. The recess may be a through hole or a non-through hole or cavity extending into the body of the first or second element. The third element may be a tube or rod section having a circular, elliptical, rectangular, triangular, or another cross sectional shape. The recess may instead be configured as a groove or track configured to at least partly receive the free end of the third element or a head thereof. The recess and/or groove may have the same configuration and size as the outer configuration of the third element and/or head thereof

The third element and the recess may alternatively be replaced by a guide wire arrangement comprising one or more guide wires which at one end is coupled to at least one of the first or second elements or cable spacing plates, e.g.,via a spring element. The other end may be coupled to another spring element located on the same or the other element or cable spacing plate. The guide wires may be guided through one or more pulleys located on one or both elements or cable spacing plates.

According to one embodiment, at least one of the first and second elements comprises at least one first finger extending out from an outer surface of that element, and the other element comprises at least one second finger extending out from an outer surface of that element, wherein the first and second contact surfaces are located on the two fingers respectively.

This allows the individual cable spacing plates to be rotated using a mechanical engagement between the two first elements. The first and/or second fingers may be configured as a tap or pin having a planar or curved, e.g.,convex or concave, contact surface. The fingers preferably comprise a planar contact surface for reduced wear and enhanced engagement between the two elements. The first and second fingers may extend in opposite parallel directions relative to each other. The first and second fingers may instead extend in different directions, e.g.,in perpendicular directions relative to each other. A deformable element, e.g.,of plastic, rubber, or another deformable material may be arranged on one or both of the contact surfaces for absorbing the shocks between the two engaging elements.

The first and/or second fingers may have a length between 2-20 cm, preferably between 5-15 cm. The first and/or second fingers may have a maximum thickness between 1-10 cm, preferably between 2-5 cm.

The first and/or second element may comprise at least two first fingers arranged relative to each other which define a first and second end positions for the movement of a mating second finger on the opposite element. The mating finger may comprise two contact surfaces for contacting a contact surface on each of the two fingers respectively. This allows the upper cable spacing plate to rotate between a first angle of rotation and a second angle of rotation relative to the lower cable spacing plate. This prevents the upper cable spacing plate from rotating beyond a maximum allowable angle relative to the lower cable spacing plate in either yaw direction, thus reducing the bending forces and the wear acting on the cables. The first and second angles of rotation may be determined based on the maximum allowable twist of the cable twisting system, the length of the cable twisting system, and the number of cable spacing plates. At least three first fingers may be arranged on one of the two elements while at least two second fingers are arranged on the other element for improving the engagement between the two elements and reducing the load for each of the fingers.

The cable twist system may have a length between 5-20 m, preferably between 10-15 m and/or comprise 5-20 sections distributed along the length of it. The cable twist system may be configured to operate at a maximum allowable twist between ±360-1800 degrees, preferably between ±720-1080 degrees. The first element may be configured to have a first and/or second angle of rotation between ±30-210 degrees relative to the second element at the maximum twist. This may also define the maximum allowable rotation between two adjacent cable spacing plates. The fingers may be angled relative to each other so that they form an angle between 30-180 degrees, preferably between 60-120 degrees.

According to a particular embodiment, at least one of the first and second elements is configured as a claw half-clutch in which the respective fingers are located on a side surface and face towards the other element.

This allows the two engaging elements to be configured as a claw clutch mechanism comprising two clutch-halves each comprising a predetermined number of interacting fingers facing each other. Each of the two elements may comprise a plate coupled to a number of first fingers in the form of teeth, e.g.,one, two, three, four, five, or more. The fingers may be formed as part of the plate or may be coupled to the plate by means of any known fastening technique, e.g.,welding or gluing, or fastening means, e.g.,screws or bolts. Alternatively, one of the clutch-halves may be omitted and then an element comprising a central body in the form of a plate, where the fingers are coupled to the peripheral edge of the plate or form part of the plate, may be used instead.

According to a particular embodiment, the first element comprises a first end surface facing a second end surface on the second element, wherein the two end surfaces are spaced apart when the nacelle has a yawing angle of zero, and wherein the second end surface is moved in an axial direction towards the first element and past the first end surface when the first element is rotated relative to the second element.

The first and second elements may be placed in a first position where the fingers on the two elements are completely disengaged and spaced apart when the upper cable spacing plate is not rotated relative to the lower cable spacing plate. The fingers of the second element may then be brought into engagement with the fingers of the first element by moving the second element in a spiral direction relative to and towards the first element. This allows the two engaging elements to be brought into contact with each other in a simple manner. The engagement between the two elements also prevents the lower cable spacing plate from being moved further towards the upper cable spacing plate as the two cable spacing plates are moved together. This prevents the cable around that section from being subjected to any further bending forces and wearing as the nacelle continuous to yaw in the same direction.

The first end surface may be placed at a distance between 1-50 mm, preferably between 5-30 mm, from the second end surface when the nacelle is positioned in its neutral position, i.e. has a yawing angle of zero. When the two contact surfaces are brought into contact with each other, the second end surface may additionally contact a side surface of the first element.

According to one embodiment, at least one of the first and second elements is coupled to an intermediate element at one end which, at the other end, is coupled to the respective cable spacing element.

The first or second element may be coupled to an intermediate element in the form of a tube or rod section. The first or second element may be located at or near one end of the intermediate element. The other end of the intermediate element may be configured to be coupled directly to the respective cable spacing element or via a mounting plate. This allows the first and second elements to be located near one of the cable spacing plates. The first and second elements may be coupled to a first and second intermediate element respectively where the two intermediate elements may have the same or different lengths. This allows the first and second elements to be located at a predetermined distance from the one of the cable spacing plates, e.g.,in the middle of the section formed by the cable spacing plates.

The third element may be coupled to the centre of the second element and the recess may be located in the centre of the first element, or vice versa. The third element may be configured as a removable element in the form of a tube or rod section which may be mounted to the structure by means of a bushing or any known fastening means, e.g.,bolts, nuts, screws, pins, or the like. The third element may extend into a cavity of the respective intermediate element and optionally also into a cavity of the other intermediate element. The third element may be mounted to any one of the intermediate elements and/or any of the first and second elements. If only first or second element is coupled to an intermediate element, then the third element may extend into a cavity of a first element, a second element, or an intermediate element located in an adjacent section of the cable twisting system.

The first element and/or the second element may be coupled to a torsion rod or spring arranged in the centre of the cable spacing plates. The torsion rod or spring may be coupled to two adjacent cable spacing plates or the uppermost and lowermost cable spacing plates.

The third element may have a maximum outer diameter or thickness between 30-70 mm, preferably between 40-60 mm. The recess of the first element and/or the cavity of the intermediate element may have a maximum inner diameter or thickness which is between 0-10 mm, preferably between 1-5 mm, greater than the maximum outer diameter or thickness of the third element.

According to one embodiment, the lowermost cable spacing plate relative to the nacelle is configured to be mounted to a support unit arranged inside the wind turbine tower.

This allows the cable spacing plates to rotate relative to the nacelle when it is yawing which allows the twist to start at the uppermost cable spacing plate. The electrical cables guided along the cable twisting system follow the rotation and/or upwards movement of the cable spacing plates as the cables are twisted instead of moving up or down relative to a stationary cable spacing plate. This reduces the wear on the insulation of the conductive material of the cables.

The lowermost cable spacing plate may be located at least 8 m, preferably 10 m or more, from the bottom of the nacelle. The wind turbine tower may have an outer height of at least 75 m, preferably at least 80 m where the bottom of the nacelle is located more or less in the same height.

According to one embodiment, the guiding means form a number of an open ended area or a closed off area which are configured to receive at least one of the cables.

The guiding means may be a number of fingers or protrusions arranged along the periphery of the cable spacing plate. The fingers extend in a radial direction outwards from the cable spacing plate and may form a number of open ended areas between the fingers which are configured to receive at least one of the cables. The open area may have a depth and/or width which more or less correspond to the thickness of the cable or group of cables located in that area. This allows the cables to hang loosely or uncoupled in the open area which minimizes the stresses in the cables normally occurring when the cables are twisted. The open area may be closed off by a clamping band, ring, or wire arranged along the free ends of the fingers. The stresses may be reduced even further by providing the fingers with one or more curved side surfaces, e.g.,forming a plano-convex or biconvex shape where the thickness of the finger increases from the ends and towards the middle.

The guiding means may instead be a number of through holes arranged in the cable spacing plate which define a closed off area in which the cables may be located. The through holes may have a diameter which more or less corresponds to the thickness of the cable or group of cables located in that hole. The cables may be arranged in small bundles where at least one bundle may be placed in each of the holes. The holes may either be arranged with a certain distance between each hole or arranged in groups of at least two with a certain distance between each group. The cables may hang freely or loosely in the holes or may be held in place relative to the cable spacing plate, e.g.,by clamping means or a bushing/sleeve located on one or both side surfaces of that plate or by simply friction between the cables and the side surface of the hole. The holes may be arranged near the periphery and/or the middle of the cable spacing plate. This keeps the cables at an acceptable temperature even when the wind turbine is producing energy at its maximum at high ambient temperatures.

The cable spacing plates may be formed as a disc or ring having a circular or polygonal shape. The shape of the cable spacing plate defines an outer periphery with an out-scribed circle having a diameter of 30 mm or more, preferably between 40-1500 mm. The fingers or through holes may have a length or diameter of 30-200 mm, preferably 50-150 mm. Three or more fingers or through holes, preferably between five and fifteen, may be arranged at or near the outer periphery of the cable spacing plate.

### BRIEF DESCRIPTION OF THE DRAWING

FIG. 1 shows an exemplary embodiment of a wind turbine;

FIG. 2 is a perspective view of an exemplary embodiment of a first element of a unit for rotating the cable spacing plates in a cable twisting system;

FIG. 3 is a perspective view of an exemplary embodiment of a second element of the unit for rotating the cable spacing plates in a cable twisting system;

FIG. 4a-b are perspective views showing a second exemplary embodiment of the unit according to the invention;

FIG. 5a-b shows the unit shown in FIGS. 4a, 4b mounted in an exemplary cable twisting system;

FIG. 6 is a perspective cross-sectional view of one of the cable spacing plates shown in FIGS. 5a, 5b;

FIG. 7 is a perspective cross-sectional view of the unit shown in FIGS. 4a, 4b in a first position;

FIG. 8a-b are persepective views of the cable twisting system shown in FIGS. 5a, 5b with a plurality of cables arranged in the guiding means; and

FIG. 9 shows an exemplary embodiment of a support unit coupled to the lowermost cable spacing plate.

### DETAILED DESCRIPTION OF THE INVENTION

In the following text, the figures will be described one by one and the different parts and positions seen in the figures will be numbered with the same numbers in the different figures. Not all parts and positions indicated in a specific figure will necessarily be discussed together with that figure.

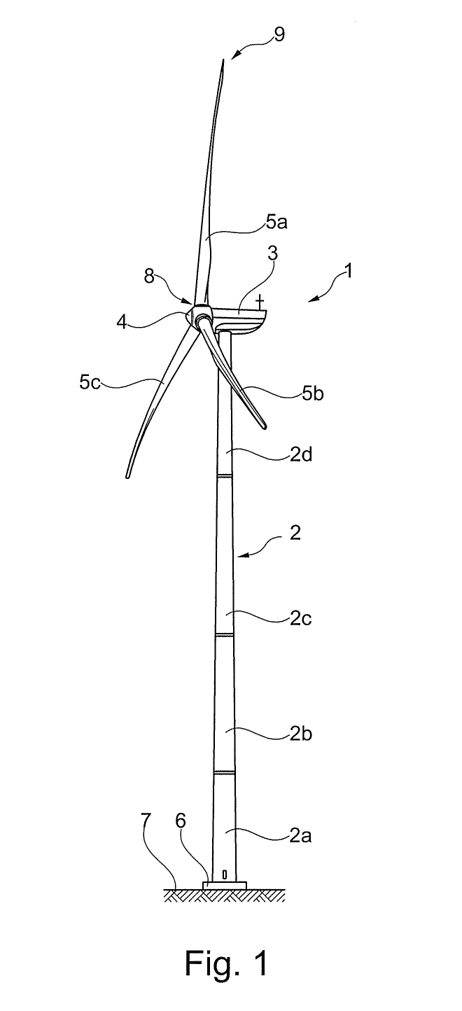

FIG. 1 shows an exemplary embodiment of a wind turbine 1 comprising a wind turbine tower 2 and a nacelle 3 arranged at top of the wind turbine tower 2. The nacelle 3 may be coupled to one or more yaw bearings (not shown) located at the top of the wind turbine tower 2 so that the nacelle 3 may yaw relative to the wind turbine tower 2. A separate circuit (not shown) configured to determine the yawing or twist of the nacelle 3 relative to its initial position may be coupled to the yaw bearing. The wind turbine tower 2 may comprise one or more tower sections 2a-d mounted on top of each other. A rotor hub 4 may be rotatably mounted to the nacelle 3 via a rotor shaft (not shown). One or more wind turbine blades 5 may be mounted to the rotor hub 4 via a shaft extending outwards from the centre of the rotor hub. At least two, preferably three, wind turbine blades 5a-c may be mounted to the rotor hub 4 where the wind turbine blades 5 form a rotation plane. The wind turbine tower 2 may be mounted onto a foundation 6 extending above a ground level 7.

The wind turbine blade 5 may comprise a blade root 8 configured to be mounted to the rotor hub 4. The wind turbine blade 5 may comprise a tip end 9 arranged at the free end of the blade 5. The wind turbine blade 5 has an aerodynamic profile along the length of the blade. The wind turbine blade 5 may be made of fibre reinforced plastics or composites, e.g.,having fibres made of glass, carbon, or organic fibers which form a laminate. The laminate may be infused using a resin, e.g.,epoxy, supplied by an external system, e.g.,a vacuum infusion system.

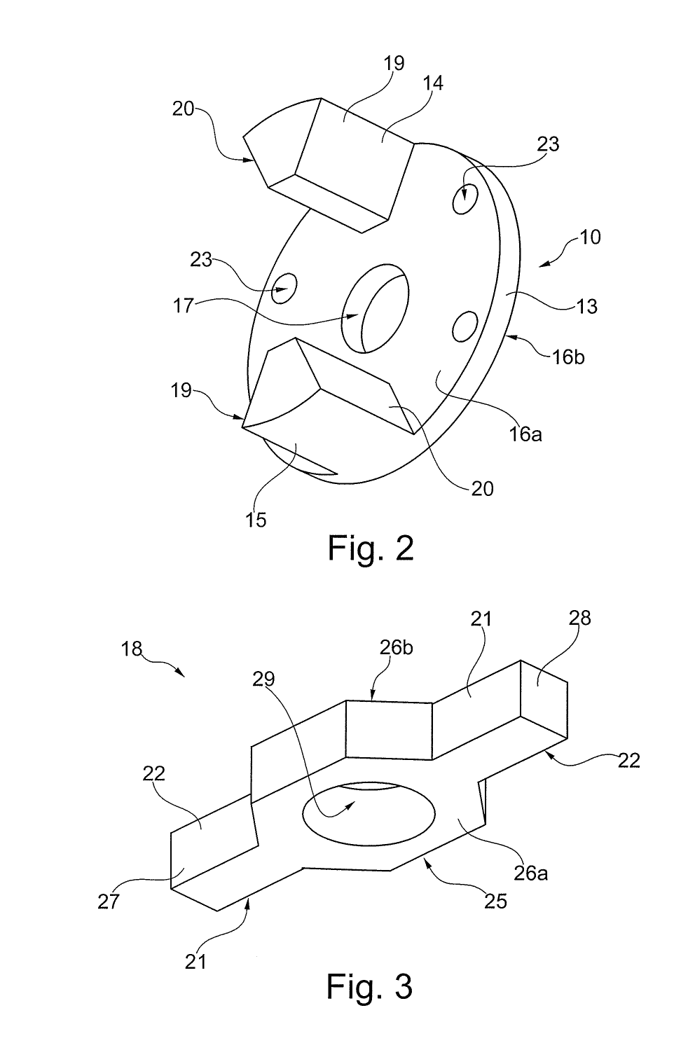

FIG. 2 shows an exemplary embodiment of the first element 10 configured to be coupled to a cable spacing plate 11 in the cable twisting system 12. The first element 10 may be configured as a claw half-clutch comprising a plate 13 and one or more fingers 14, 15. The plate 13 may comprise a first side surface 16a and a second side surface 16b. The fingers 14, 15 in the form of teeth may be coupled to one of the side surfaces 16. The fingers 14, 15 may extend outwards from the first element 10. The fingers 14, 15 may extend outwards in a direction parallel to the plane formed by the plate 13, e.g.,out from the side surface 16a of the plate. Preferably, two fingers 14, 15 may be arranged in a predetermined angle relative to each other, e.g.,facing away from each other. The fingers 14, 15 may be formed as part of the plate 13.

The plate 13 may be configured to be coupled to the cable spacing plate 11 when mounted, e.g.,via an intermediate element. A hole 17, e.g.,a through hole, may be arranged in the plate 13. The hole 17 may be configured to receive the intermediate element or the suspension element (not shown) in the form of a torsion rod or spring which may be coupled to at least two cable spacing plates in the cable twisting system 12. One of the side surfaces 16 also forms an end surface which faces a second element 18 when mounted.

A first contact surface 19 may be located on one or both fingers 14, 15, e.g.,on a side surface of the finger. A second contact surface 20 may be located on one or both fingers 14, 15, e.g.,on another side surface of the finger. The two contact surfaces 19, 20 may be arranged so that they face away from each other, e.g.,in opposite direction and/or are angled relative to each other, e.g.,in an acute angle. The contact surfaces 19, 20 may be configured to contact a mating contact surface 21, 22 on the second element 18 when the two elements 10, 18 are brought into engagement. The finger 14, 15 may be formed as a trapezium, annular, or circle sector shaped element with planar contact surfaces 19, 20.

One or more mounting means 23 may be arranged on the plate 13. The mounting means 23 may be configured to mount the first element 10 to the cable spacing plate 11. The mounting means 23 may be mounting holes, e.g.,through holes, configured to receive fastening means, such as bolts, nuts, screws, rivets, or the like, for mounting the first element 10 firmly to the cable spacing plate 11.

The first element 10 may be made of metal, e.g.,iron or steel, or plastics, e.g.,polycarbonate, polyester or polymer, glass/organic fibre reinforced plastics/composite or another suitable material. The finger 14, 15 may have a length between 2-20 cm. The finger 14, 15 and/or the plate 13 may have a maximum thickness between 1-10 cm.

FIG. 2 shows an exemplary embodiment of the second element 18 configured to be coupled to a cable spacing plate 24 in a cable twisting system 12. The second element 18 may comprise a central body 25 in the form of a plate having a first side surface 26a and a second side surface 26b. One or more fingers 27, 28 in the form of a tap or pin may extend outwards from the central body 25. The fingers 27, 28 may extend outwards in a direction parallel to the plane formed by the central body 25, e.g.,out from the peripheral edge of the plate. Preferably, two fingers 27, 28 may be arranged in a predetermined angle relative to each other, e.g.,facing away from each other. The fingers 27, 28 may be formed as part of the central body 25.

The central body 25 may be configured to be coupled to the cable spacing plate 24 when mounted, e.g.,via an intermediate element. A hole 29, e.g.,a through hole, may be arranged in the central body 25. The hole 29 may configured to receive an intermediate element or a suspension element (not shown) in the form of a torsion rod or spring which may be coupled to at least two cable spacing plates in the cable twisting system 12. One of the side surfaces 26 also forms an end surface which faces the first element 10 when mounted.

A first contact surface 21 may be located on one or both fingers 27, 28, e.g.,on a side surface of the finger. A second contact surface 22 may be located on one or both fingers 27, 28, e.g.,on another side surface of the finger. The two contact surfaces 21, 22 may be arranged so that they face away from each other, e.g.,in opposite direction. The contact surfaces 21, 22 may be configured to contact the contact surface 19, 20 on the first element 10 when the two elements 10, 18 are brought into engagement. The finger 27, 28 may be formed an elongated element with planar contact surfaces 21, 22.

The second element 18 may be made of metal, e.g.,iron or steel, or plastics, e.g.,polycarbonate, polyester or polymer, glass/organic fibre reinforced plastics/composite or another suitable material. The finger 27, 28 may have a length between 2-20 cm. The finger 27, 28 and/or the central body 25 may have a maximum thickness between 1-10 cm.

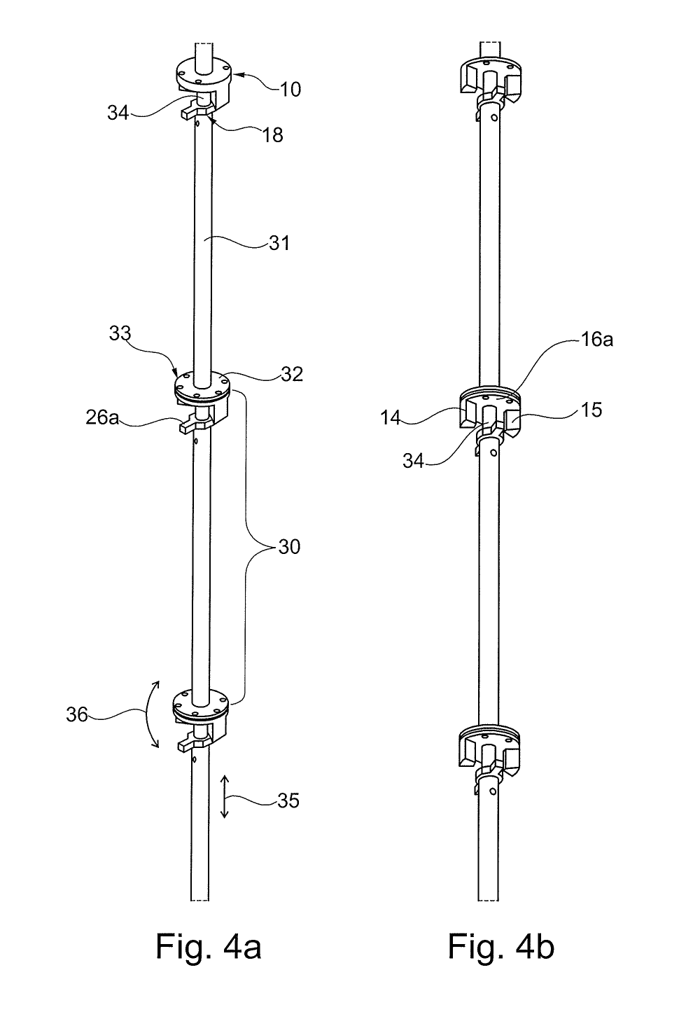

FIGS. 4a, 4b show a second exemplary embodiment of a unit 30 for rotating the cable spacing plates 11, 24 in the cable twisting system 12 according to the invention. The first element 10 and the second element 18 may together form the unit 30.

At least the second element 18 may be coupled to an intermediate element 31, e.g.,at one end of the element 3L The intermediate element 31 may at the other end be configured to be coupled to a cable spacing plate 11, 24, e.g.,via a mounting plate 32. The plate 32 may comprise a number of mounting holes 33, e.g.,through holes, as shown in FIG. 4a. The holes 33 may be configured to receive fastening means, such as bolts, nuts, screws, rivets, or the like, for mounting the intermediate element 31 firmly to a cable spacing plate 24. Preferably at least four or six mounting holes 33 may be arranged in the plate 32. The intermediate element 31 may be configured as a tube section forming a cavity connected to an opening in both ends of the tube section.

A third element 34 in the form of a tube or rod section may be arranged between the first element 10 and the second element 18. The third element 34 may form part of the unit 30. The third element 34 may be configured to guide the movement of the second element 18 relative to the first element 10 when the nacelle 3 is yawing for achieving an optimal engagement. An optimal engagement is defined as a position where the two of the contact surfaces 19, 20, 21, 22 are aligned over each other so that a large contact area is achieved. The third element 34 may be configured to guide the second element 18 in at least an axial direction relative to the first element 10, wherein the direction is parallel to the axial direction of the cable twisting system 12. The third element 34 may be made of metal, e.g., iron or steel, or plastics, e.g.,polycarbonate, polyester or polymer, glass/organic fibre reinforced plastics/composite, or another suitable material.

The second element 18 may be arranged on the intermediate element 31 so that the end surface 26a faces towards the end surface 16a and the fingers 14, 15 of the second element 18, as shown in FIG. 4b. The other side surface 26b may be arranged so that it faces towards the mounting plate 32 of the intermediate element 31. The third element 34 may be configured to align the first and second elements 10, 18 relative to each other when mounted so that the movement of the second element 18 relative to the first element 10 is limited to an axial movement (marked with arrow 35). The third element 34 may be configured to allow at least one of the elements 10, 18, preferably the first element 10, to additionally or alternatively rotate relative to the second element 18 (marked with arrow 36) when the nacelle 3 is yawing.

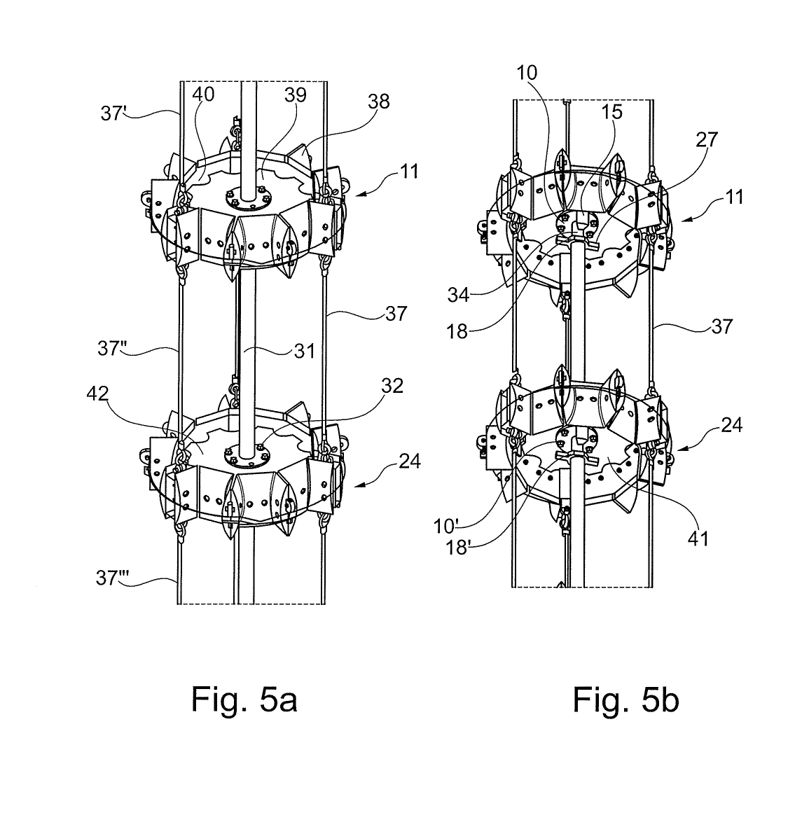

FIGS. 5a, 5b show the unit 30 mounted in an exemplary cable twisting system where the first element 10 may be coupled to a first cable spacing plate 11 and the second element 18 may be coupled to a second cable spacing plate 24 via the intermediate element 31. The individual cable spacing plates 11, 24 may be coupled to each other by two or more suspension wires 37 or ropes. The suspension wire 37 may be formed by a number of suspension wires 37′, 37″, 37′″ coupled to two adjacent cable spacing plates 11, 24, as shown in FIGS. 5a-b.

The cable spacing plates 11, 24 may be formed as a disc or ring having a plurality of guiding means 38 for guiding a plurality of cables extending downwards from the nacelle 3. The cable spacing plate 11, 24 may comprise an inner support element 39 in the form of a plate coupled to an outer support element 40 in the form of an annular plate on which the guiding means 38 may be arranged. The individual cable spacing plates 11, 24 form a number of sections along the length of the cable twisting system 12 in which the unit 30 may be arranged.

The cable spacing plates 11, 24 may be made of metal (e.g.,iron or steel), plastics (e.g.,polycarbonate, polyester, or polymer), glass/organic fibre reinforced plastics/composite, or another suitable material. A protective and/or friction reducing plastic, coating, or skin (not shown) may be arranged on the metallic parts of the cable spacing plates 11, 24.

The first element 10 may be positioned relative to the second element 18 so that the fingers 14, 15 are offset relative to the fingers 27, 28, as shown in FIG. 5b. At least one of the cable spacing plates 11 is configured to rotate relative to another cable spacing plate 24 due to the twisting of the cables (not shown). The fingers 14, 15, 27, 28 may be arranged so that two mating fingers are brought into contact with each other when the second element 18 is moved towards the first element 10.

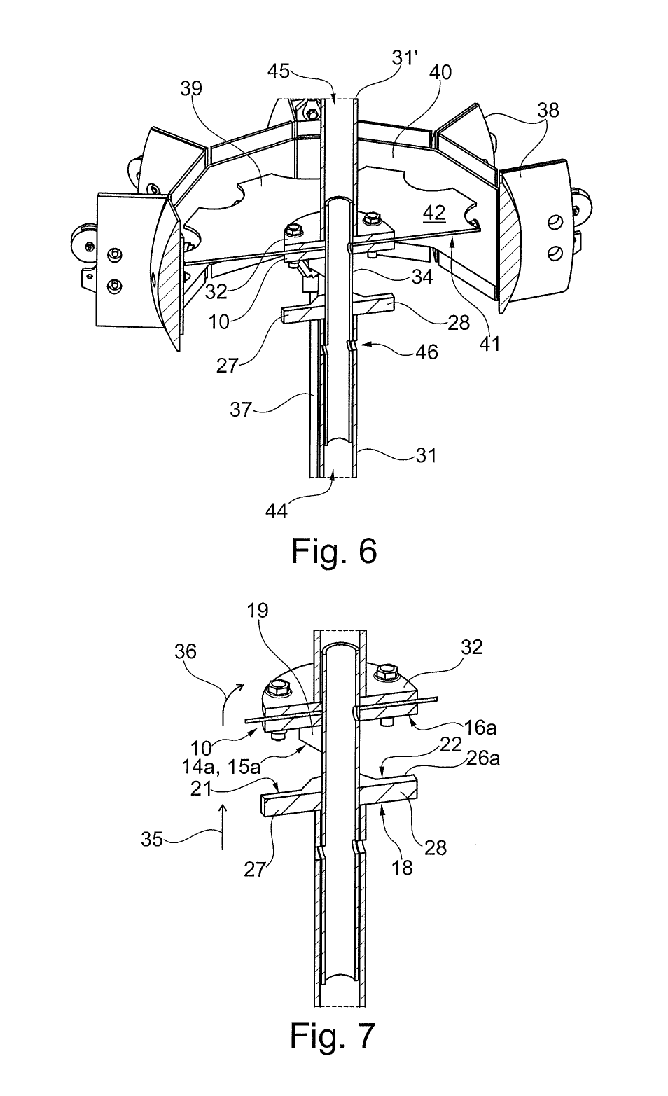

FIG. 6 shows a cross section of the cable spacing plate 11, 24 where the side surface 16b of the first element 10 may contact a first side surface 41 of the cable spacing plate 11, 24. A side surface of the mounting plate 32 facing the cable spacing plate 11, 24 may contact a second side surface 42 of the cable spacing plate 11, 24. The mounting plate 32 and the plate 13 may be coupled together by fastening means 43, such as bolts, nuts, screws, or the like which may extend through the holes 23, 33 and a hole (not shown) or cut-out in the cable spacing plate 11, 24.

The third element 34 may be configured as a removable element configured to be positioned in the holes 17, 29 of the first and second elements 10, 18 when mounted. The third element 34 may extend through the second element 18 and into a recess 44 of the intermediate element 31, as shown in FIG. 6. The third element 34 may additionally or alternatively extend through the first element 10 and into a recess 45 of another intermediate element 31′. The recesses 44, 45 may form parts of the through hole connected to an opening in both ends of the intermediate element 31, 31′. The recesses 44, 45 may be configured to receive the third element 31 so that it may slide inside the recess 44, 45 when the nacelle 3 is yawing. The third element 34 may be coupled to one of the element 10, 18 by means of a fastening element (not shown), e.g.,a bolt, a screw, a locking pin, or the like. The fastening element may be placed in a hole 46, e.g.,a through hole, located in the respective element 18 and the third element 34.

The third element 34 may have a maximum outer diameter or thickness between 30-70 mm. The recesses 44, 45 of the element 31 and/or the holes 17, 29 may have a maximum inner diameter or thickness which is between 0-10 mm greater than the maximum outer diameter or thickness of the third element 34.

FIG. 7 shows a cross section of the unit 30 in a first position where the nacelle 3 and thus the unit 30 is positioned in a neutral position, i.e. has a yawing angle of zero. In this position, the first element 10 is disengaged from the second element 18 so that the first and second contact surfaces 19, 20, 21, 22 on the mating fingers 14, 15, 27, 28 are offset relative to each other. The two end surfaces 16a, 26a are spaced apart so that the end surfaces 14a, 15a of the fingers 14, 15 are placed at a predetermined distance from the fingers 27, 28, e.g.,the end surface 26a.

The first finger 27 may define a first end position for the rotation, e.g.,radial movement in a first direction, of the first element 10 relative to the second element 18. The first end position may be defined as the position where the first contact surfaces 19, 21 are brought into contact with each other. The second finger 28 may define a second end position for the rotation, e.g.,radial movement in the opposite direction, of the first element 10 relative to the second element 18. The second end position may be defined as the position where the second contact surfaces 20, 22 are brought into contact with each other. The two end positions may also define a first and second angle of rotation of the first element 10 and thus the cable spacing plate 11. The mating fingers 14, 15, 27, 28 may be arranged so that they are brought into contact with each other at either of the end positions.

The first end surface 14a, 15a may be placed at a distance between 1-50 mm, preferably between 5-30 mm, from the second end surface 26a when the nacelle 3 is positioned in its neutral position. The end surface 26a may additionally contact the side surface 16a of the first element 10 when the two contact surfaces 19, 20, 21, 22 are brought into contact with each other.

As the nacelle 3 is yawing, the twisting of the cables causes the first cable spacing plate 11 to rotate 36 relative to the second cable spacing plate 24. The second cable spacing plate 24 and thus the second element 18 are then moved in an axial direction 35 towards the first cable spacing plate H and thus the first element 10. The end surface 26a is moved past the end surfaces Ma, 15a, as the first element 10 continuous to rotate relative to the second element 18. When the second element 18 reaches a second position, the first or second contact surfaces 19, 20, 21, 22 are then brought into contact with each other and the two elements 10, 18. The second position also defines the end positions. The two cable spacing plates 11, 24 are then rotated together in the same direction. This causes another first element 10′ coupled to the side surface 41 of the cable spacing plate 24 to rotate relative to another second element 18′ coupled to an adjacent cable spacing plate, as shown in FIG. 5b, until it reaches another first or second end position. The adjacent cable spacing plate then rotates together with the cable spacing plates 11, 24, and so on.

When the nacelle 3 starts to yaw in the opposite direction, the cables and thus the cable spacing plates 11, 24 are untwisted in a reverse order.

The first and second angles of rotation may be determined based on the maximum allowable twist of the cable twisting system 12, the length of the cable twisting system 12 and the number of cable spacing plates 11, 24. The cable twist system 12 may have a length between 5-20 m and/or comprise 5-20 sections distributed along the length of it. The cable twist system 12 may be configured to operate at a maximum allowable twist between ±360-1800 degrees. The second element 18 may be configured to have a first and/or second angle of rotation between ±30-210 degrees relative to the first element 10 at the maximum twist. This may also define the maximum allowable rotation between two adjacent cable spacing plates 11, 23.

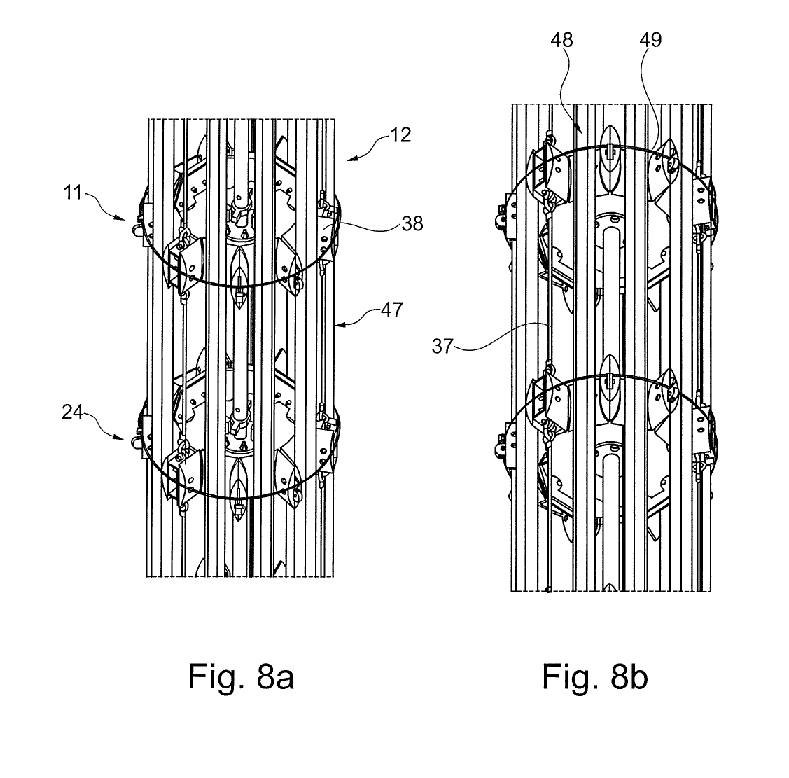

FIGS. 8a, 8b show the cable twisting system 12 with a plurality of cables 47 arranged in the guiding means 38. The guiding means 38 may be configured as a number of fingers arranged along the outer support element 40 of the cable spacing plate 11, 24. The fingers may extend outwards in a lateral direction relative to the axial direction of the cable spacing plate 11, 24, as shown in FIGS. 8a-b. The fingers 38 may form part of the outer support element 40. The fingers 38 may instead be coupled to the support element 40 by any fastening technique, such as welding, gluing, bonding, or the like, or by use of fastening means, such as bolts, nuts, screws, rivets, or the like.

The fingers 38 may form a number of open ended areas 48 or recesses located between the fingers which are configured to receive one or more cables 47. The cables 47 may comprise one or more electrical cables electrically coupled to the nacelle 3, e.g.,a generator inside the nacelle 3. The cables 47 may be arranged in a number of bundles where at least one bundle may be arranged in each of the open ended areas 48. The open ended area 48 may have a depth and/or width which more or less correspond to the maximum thickness of the cable or bundle of cables located in that area. The open ended areas 48 may be configured so that the cables 47 or bundles of cables hang loosely or uncoupled in the open ended area 48. The open ended area 48 may be closed off by means of a clamping band, ring, or wire 49 arranged along the free ends of the fingers.

The cable spacing plate 11, 24 may comprise an outer periphery with an out-scribed circle having a diameter of 30 mm or more. The fingers 38 may have a length and/or diameter of 30-200 mm. Three or more fingers 38 may be arranged at the outer periphery of the cable spacing plate 11, 24.

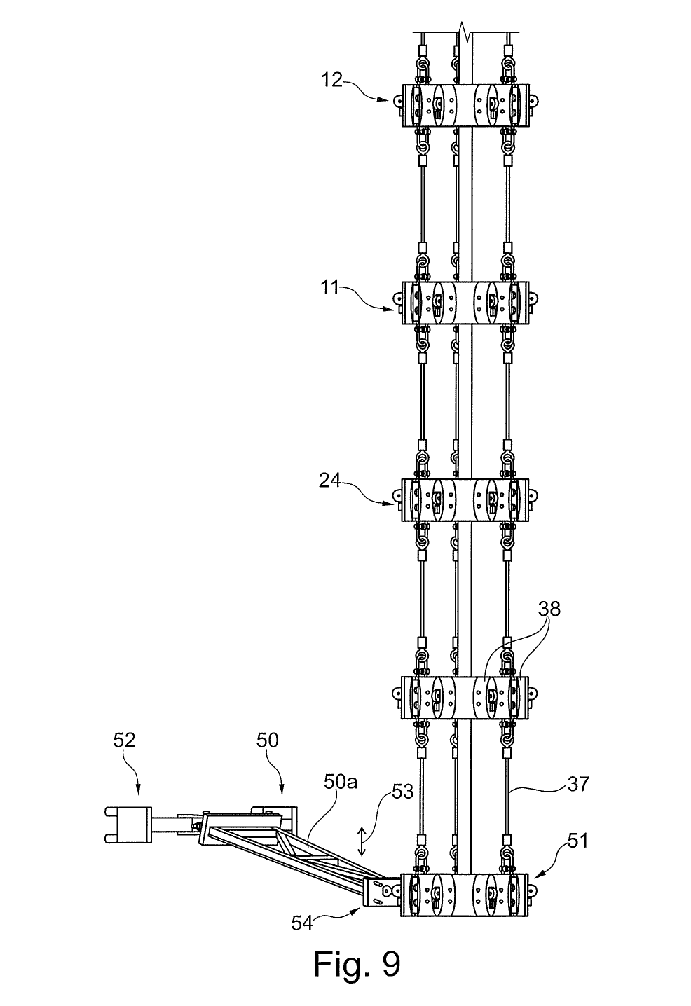

FIG. 9 shows an exemplary embodiment of a support unit 50 coupled to the lowermost cable spacing plate 51. The cable twisting system 12 may be configured to be arranged inside the wind turbine tower 2 for guiding the cables 47 extending downwards from the nacelle 3 to the bottom of the wind turbine tower 2. The cable twisting system 12 may be arranged at or near the top (not shown) of the wind turbine tower 2. Mounting means in the form of one or more wires, rods, or bolts may be used to couple the cable twisting system 12 to the bottom of the nacelle 3 and/or the top of the wind turbine tower 2.

The support unit 50 may be configured to be pivotally coupled to the inner side surface of the wind turbine tower 2, e.g.,via a mounting bracket 52 forming a pivot point. The support 50 may be configured to pivot relative to the mounting bracket 52 so that it is able to follow to the axial movement 53 of the lowermost cable spacing plate 51.

The support unit 50 may at the other end be configured to prevent the cable spacing plate 51 from rotating relative to the nacelle 3 as the cables 47 are twisted. The support unit 50 may comprise a central support element 50a which may be coupled to the cable spacing plate 51, e.g.,by a mounting bracket 54. The mounting bracket 54 may be coupled to the cable spacing plate 51, e.g.,one or more of the guiding means 38, by fastening means, such as bolts, screws, nuts, or the like. The support unit 50 may alternatively be coupled to the lowermost end of a suspension element, e.g.,a torsion rod or spring, extending downwards from the cable spacing plate 51.

The lowermost cable spacing plate 51 may be positioned at a distance of at least 8 m from the bottom of the nacelle 3. The wind turbine tower 2 may have an outer height of at least 75 m where the bottom of the nacelle 3 is located more or less in the same height.

What is claimed is:

1. A wind turbine comprising:
a wind turbine tower having an inner side, a bottom, and a top;
a nacelle arranged at the top of the wind turbine tower, wherein the nacelle is coupled to at least one yawing unit configured to rotate the nacelle relative to the wind turbine tower;
a rotor hub rotatably mounted to the nacelle, wherein at least one wind turbine blade is mounted to the rotor hub;
a cable twisting system configured to be arranged inside the wind turbine tower, where the cable twisting system comprises a number of cable spacing plates coupled to at least one suspension element, wherein the cable spacing plates are distributed along a length of the cable twisting system and comprise a number of guiding means configured to guide a number of electrical cables extending out from the bottom of the nacelle and into the inside of the wind turbine tower in a direction towards the bottom of the wind turbine tower,
wherein
a first element is configured to be firmly coupled to a first cable spacing plate, the first element extending out from the first cable spacing plate towards a second cable spacing plate when mounted;
a second element is configured to be firmly coupled to the second cable spacing plate, the second element extending out from the second cable spacing plate towards the first cable spacing plate when mounted; and
the first element is configured to rotate relative to the second element when the nacelle is yawing until a first contact surface on the first element is brought into contact with a second contact surface on the second element, after which the first and second elements are rotated together.

2. A wind turbine according to claim 1, wherein a third element is configured to be coupled to at least one of the first and second elements, and wherein the third element is configured to guide the movement of the second element in an axial direction relative to the first element when the nacelle is yawing.

3. A wind turbine according to claim 2, wherein the third element comprises at least one free end, and the first or second element comprises a recess configured to at least partly receive the free end when mounted, and wherein the free end is configured to be moved along the recess when the nacelle is yawing.

4. A wind turbine according to claim 1, wherein at least one of the first and second elements comprises at least one first finger extending out from an outer surface of that element, and the other element comprises at least one second finger extending out from an outer surface of that element, and wherein the first and second contact surfaces are located on the two fingers respectively.

5. A wind turbine according to claim 4, wherein at least one of the first and second elements is configured as a claw half-clutch in which the respective fingers are located on a side surface and face towards the other element.

6. A wind turbine according to claim 4, wherein the first element comprises a first end surface facing a second end surface on the second element, wherein the two end surfaces are spaced apart when the nacelle has a yawing angle of zero, and wherein the second end surface is moved in an axial direction towards the first element and past the first end surface when the first element is rotated relative to the second element.

7. A wind turbine according to claim 1, wherein at least one of the first and second elements are coupled to an intermediate element at one end which, at the other end, is coupled to the respective cable spacing element.

8. A wind turbine according to claim 1, wherein the lowermost cable spacing plate relative to the nacelle is configured to be mounted to a support unit arranged inside the wind turbine tower.

9. A wind turbine according to claim 1, wherein the guiding means form a plurality of an open ended areas, each of which is configured to receive at least one of the cables.

10. A wind turbing according to claim 1, wherein the guiding means form a plurality of clais off areas, each of which is configured to receive at least one of the cables.

11. A wind turbine according to claim 5, wherein the first element comprises a first end surface facing a second end surface on the second element, wherein the two end surfaces are spaced apart when the nacelle has a yawing angle of zero, and wherein the second end surface is moved in an axial direction towards the first element and past the first end surface when the first element is rotated relative to the second element.
